(19) United States
(12) Patent Application Publication
(10) Pub. No.: US 2009/0279277 A1
(43) Pub. Date: Nov. 12, 2009

(54) OPTICAL SOURCE ASSEMBLY SUITABLE FOR USE AS A SOLAR SIMULATOR AND ASSOCIATED METHODS

(76) Inventors: Douglas R. Jungwirth, Reseda, CA (US); Lynne C. Eigler, Simi Valley, CA (US)

Correspondence Address: KLEIN, O'NEILL & SINGH, LLP, 43 CORPORATE PARK, SUITE 204, IRVINE, CA, 92606, US

(21) Appl. No.: 12/128,386

(22) Filed: May 28, 2008

Related U.S. Application Data
(60) Provisional application No. 61/051,786, filed on May 9, 2008.

(51) Int. Cl. F21V 9/02; F21V 9/00

(52) U.S. Cl. 362/2; 362/293

(57) ABSTRACT

The optical source assembly/solar simulator comprises a light source, and a reflector for collecting the light and directing the light in a desired direction. In certain embodiments a spectral filter assembly receives the light from the reflector and blocks at least some of the light at specific wavelengths to produce filtered light. The spectral filter assembly is quickly and easily adjustable to vary the spectral spread of the light in the output beam. A homogenizer receives the filtered light and produces a homogenized beam having a substantially uniform irradiance distribution across the beam's cross-section and a substantially uniform spectral distribution across the beam's cross-section. In certain embodiments, a lens assembly images and sizes the homogenized beam at a point in space where a device to be tested can be placed.

### CROSS-REFERENCE TO RELATED APPLICATION

This application claims priority to provisional application Ser. No. 61/051,786, filed on May 9, 2008, the entire contents of which are hereby incorporated by reference.

### BACKGROUND OF THE INVENTION

1. Field of the Invention

The present invention relates to testing of solar cells and other optical sensors.

2. Description of Related Art

Many optical sensors, particularly solar cells, need to be tested at various stages in the production cycle to assure performance and reliability. With solar cells made using older technologies, it was sufficient to test the cells with a properly shaped, spatially uniform beam on the solar cells. For example, it was not of great importance to ensure that factors such as spectral content and range of incident angles of the light closely mimicked those of the Sun. With the advent of advanced designs for multi-junction solar cells, such as those having four, five and six junctions, the need for a source assembly/solar simulator that can take artificial light and create a beam that closely mimics sunlight in terms of spatial uniformity, angular range, and spectral profile has increased. To properly test six junction solar cells, for example, it is desirable to adjust the spectral content in each of the six individual bands that are used in the solar cell structure. Present solar simulators typically have only one or two adjustable bands. These bands are usually adjusted with static notch filters. With the introduction of six junction solar cells, this old technology is no longer suitable.

### SUMMARY OF THE INVENTION

The preferred embodiments of the present optical source assembly/solar simulator and methods have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description of the Preferred Embodiments,” one will understand how the features of the present embodiments provide advantages, which include the ability to produce a spatially well balanced output beam, the ability to easily adjust the spectral characteristics of the output beam, the ability to image the output beam to a point in space where the test sensor/solar cell is located, and the ability to control the range of angles of incidence on the test sensor/solar cell.

One embodiment of the present optical source assembly/solar simulator comprises apparatus for shaping and spectrally filtering light. The apparatus comprises a light source configured to generate light, and a reflector configured to collect the light and direct the light in a desired direction. A spectral filter assembly is configured to receive the light from the reflector and block at least some of the light at specific wavelengths to produce filtered light. A homogenizer is configured to receive the filtered light and produce a homogenized beam having a substantially uniform irradiance distribution across the beam's cross-section and a substantially uniform spectral distribution across the beam's cross-section.

Another embodiment of the present optical source assembly/solar simulator comprises apparatus for shaping and imaging light. The apparatus comprises a light source configured to generate light, and a reflector configured to collect the light and direct the light in a desired direction. A homogenizer is configured to receive the light and produce a homogenized beam having a substantially uniform irradiance distribution across the beam's cross-section and a substantially uniform spectral distribution across the beam's cross-section. A lens assembly is configured to image the homogenized beam.

One embodiment of the present methods for simulating sunlight comprises the steps of generating light, and collecting the light and directing the light in a desired direction. The method further comprises the step of filtering the light by blocking at least some of the light at specific wavelengths to produce filtered light. The method further comprises the step of homogenizing the filtered light to produce a homogenized beam having a substantially uniform irradiance distribution across the beam's cross-section and a substantially uniform spectral distribution across the beam's cross-section.

### BRIEF DESCRIPTION OF THE DRAWINGS

The preferred embodiments of the present source assembly/solar simulator and methods now will be discussed in detail with an emphasis on highlighting the advantageous features. These embodiments depict the novel and non-obvious source assembly/solar simulator and methods shown in the accompanying drawings, which are for illustrative purposes only. These drawings include the following figures, in which like numerals indicate like parts:

FIG. 1 is a side elevation view of one embodiment of the present optical source assembly/solar simulator;

FIG. 2 is a rear perspective view of the source assembly/solar simulator of FIG. 1;

FIG. 3 is a side cross-sectional view of a subassembly of the source assembly/solar simulator of FIG. 1;

FIG. 4 is a front perspective view of a subassembly of the source assembly/solar simulator of FIG. 1;

FIG. 5 is a schematic diagram of matched pairs of filter elements in the source assembly/solar simulator of FIG. 1;

FIG. 6 is a schematic side cross-sectional view of one embodiment of a homogenizer for use in the present source assembly/solar simulator;

FIG. 7 is a chart illustrating analytical results of a spectral distribution for light within the source assembly/solar simulator of FIG. 1 before the light passes through the homogenizer;

FIG. 8 is a chart illustrating analytical results of a spatial distribution for light generated by the source assembly/solar simulator of FIG. 1 after the light passes through the homogenizer;

FIG. 9 is a side elevation view of solar rays striking Earth;

FIG. 10 is a chart illustrating analytical results of an spatial distribution for light generated by the source assembly/solar simulator of FIG. 1 after the light passes through the lens assembly;

FIG. 11 is a flowchart illustrating steps in one embodiment of the present methods for simulating sunlight;

FIG. 12 is a side elevation view of another embodiment of the present optical source assembly/solar simulator; and

FIG. 13 is a side elevation view of another embodiment of the present optical source assembly/solar simulator.

### DETAILED DESCRIPTION OF THE PREFERRED EMBODIMENTS

In the detailed description that follows, the present embodiments are described with reference to the drawings. In the drawings, elements of the present embodiments are labeled with reference numbers. These reference numbers are reproduced below in connection with the discussion of the corresponding drawing features.

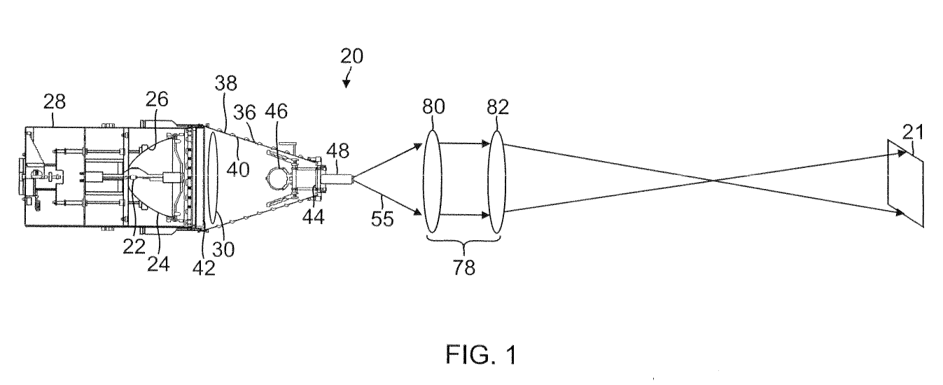

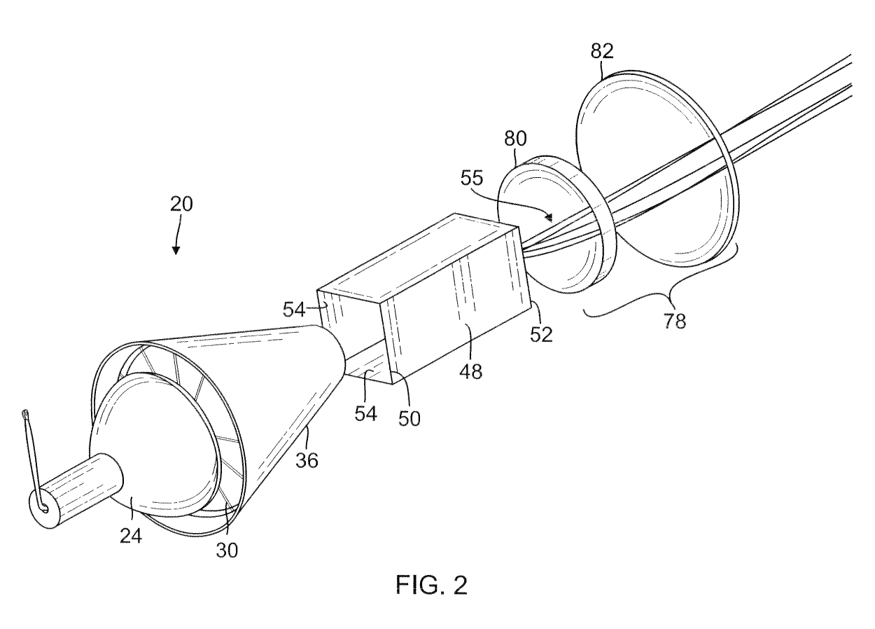

FIGS. 1 and 2 illustrate one embodiment of the present optical source assembly/solar simulator 207 which may be used for testing optical sensors, including solar cells 21. Many components shown in the accompanying figures are illustrated schematically, and the drawings are not to scale. Accordingly, the drawings should not be interpreted as limiting.

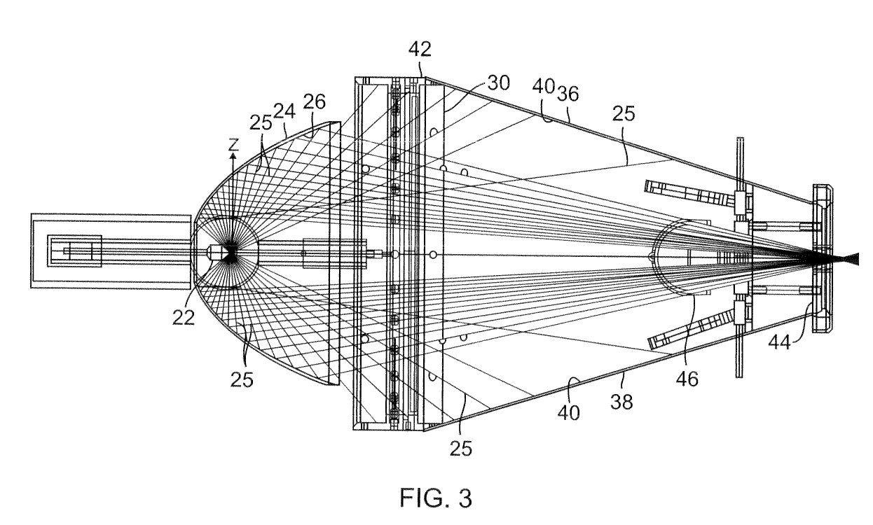

The illustrated source assembly/solar simulator 20 includes a light source 22 and a reflector 24. In one embodiment the light source 22 is a high pressure xenon (Xe) lamp, but those of ordinary skill in the art will appreciate that other light sources could be used. The reflector 24 includes a reflective internal surface 26 that collects the light emanating from the source 22 and directs it in a desired direction, as illustrated in FIG. 3, which is a side cross-sectional view of the reflector 24. The reflector 24 receives light rays 25 emanating from the light source 22. Because the internal surface 26 of the reflector 24 is reflective, the angle of reflection for each light ray is equal to its angle of incidence. The curved cross-sectional shape of the reflector 24 thus directs the light rays in the desired direction. In the illustrated embodiment, the reflector 24 has in elliptical shape when viewed in side cross-section. However, those of ordinary skill in the art will appreciate that the reflector 24 could have other shapes.

With reference to FIG. 1, the source assembly/solar simulator 20 may include a housing 28 for locating the source assembly/solar simulator components and for providing structural support and protection to components in the housing 28. Although not pictured, the source assembly/solar simulator 20 may also include a power supply for powering the lamp 22 and other components.

Light from the lamp 22 and the reflector 24 passes through a spectral filter assembly 30 that blocks at least some of the light at certain wavelengths. As described in further detail below, the spectral filter assembly 30 is adjustable, so that various amounts of light at various wavelengths can be selectively blocked. For example, in a given application it may be desirable to block 20% of the red light, 30% of the green light, and 50% of the ultraviolet light.

For this application the spectral filter assembly 30 would be adjusted to block those proportions of the light received from the lamp 22 and reflector 24. Since the spectrum of sunlight that reaches the earth's surface is influenced by the location on earth where the sunlight strikes, the spectrum that one might want to simulate is dependent upon the geographic location one wants to simulate. Thus the capability to adjust the spectrum of light generated by the source assembly/solar simulator 20 enables optical sensors and solar cells to be tested according to the location on Earth where they ultimately will be deployed. For example, the presence of certain pollutants in a given location may block a portion of the Sun's spectrum. In another location where those same pollutants are not present, the same spectral blocking would not occur.

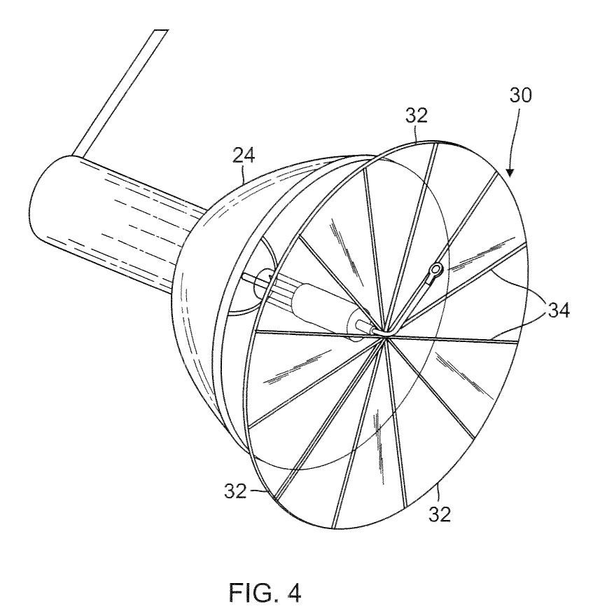

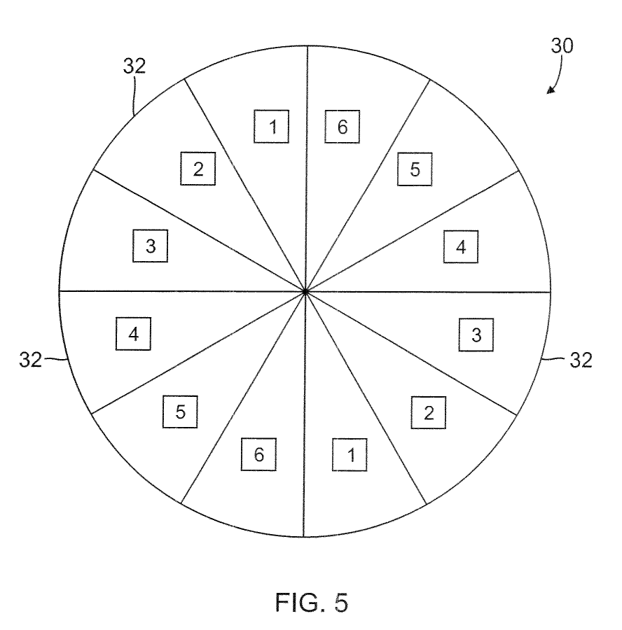

FIGS. 4 and 5 illustrate further details of the spectral filter assembly 30. In the illustrated embodiment, the spectral filter assembly 30 has a flat, pie-shaped configuration with a plurality of wedge-shaped filter elements 32. The embodiment shown includes twelve filter elements 32. However, those of ordinary skill in the art will appreciate that the spectral filter assembly 30 could include any number of filter elements 32, including just one. Further, those of ordinary skill in the art will appreciate that more than one filter assembly may be used. The filter elements 32 may be constructed of any transparent or translucent material, such as glass or plastic. The filter elements 32 may further be any color, including colorless. Further, the filter elements 32 may be either reflective or absorptive filters.

With reference to FIG. 5, in certain embodiments the filter elements 32 are organized into matched pairs. The matched pairs are indicated by the matching numbers on the filter elements 32 in FIG. 5. The members of each matched pair are diametrically opposed within the spectral filter assembly 30. The spectral filter assembly 30 thus produces a symmetrical and balanced output beam. The spectral content of the light within one portion of the beam's cross-section is closely matched with the spectral content of the light within the diametrically opposed portion of the beam's cross-section.

With reference to FIG. 4, the filter elements 32 are contained within wedge-shaped apertures 34 in the spectral filter assembly 30, and are removable and replaceable. The filter elements 32 may be configured so that each matched pair blocks a desired quantity of light within a given wavelength band. The light passing through the spectral filter assembly 30 is thus broken into a plurality of differently colored beams. Further, the filtering characteristics of the spectral filter assembly 30 can be tuned by partially or fully removing one or more filter element 32, and/or one or more matched pair of filter elements 32. Removed filter elements 32 and/or matched pairs of filter elements 32 may be replaced with filter elements 32 having different properties. When it is desired to block a greater percentage of red light, for example, one or more of the red-blocking matched pairs may be removed and replaced with a matched pair that blocks more red light. The spectral filter assembly 30 may also be configured to block light outside the visible spectrum, such as in the infrared and ultraviolet bands.

In one embodiment, the wavelength bands blocked by the matched pairs of filter elements 32 may cover the entire spectrum with little or no overlap between neighboring bands. Thus, a first matched pair of filter elements 32 may block light in the ultraviolet spectrum, a second matched pair may block light between 380 nm and 476 nm, a third matched pair may block light between 476 nm and 572 nm, etc. In other embodiments, the blocked wavelength bands may be such that some or all bands overlap with neighboring bands. Thus, a first matched pair of filter elements 32 may block light between 380 nm and 490 nm, and a second matched pair of filter elements 32 may block light between 470 nm and 590 nm. In still other embodiments, the blocked wavelength bands may be such that there are gaps between neighboring bands.

Although not pictured, the present source assembly/solar simulator 20 may further include a coarse filter located upstream from the spectral filter assembly 30. The coarse filter produces an output beam having a spectrum that is close to the desired spectrum. The adjustable spectral filter assembly 30 then fine tunes that beam to achieve the desired spectrum.

Although also not pictured, the present source assembly/solar simulator 20 may further include one or more blocking apertures. The blocking apertures may be positioned downstream from the spectral filter assembly 30. The blocking apertures may, for example, comprise a disk with one or more wedge-shaped opaque apertures. In one embodiment the blocking apertures may comprise a diametrically opposed pair of opaque apertures. By rotating the disk, the pair of opaque apertures may be positioned in front of a desired matched pair of filter elements 32 to starve the output from the simulator 20 of light in desired wavelengths.

With reference to FIGS. 1-3, the light exiting the spectral filter assembly 30, the filtered light, passes through a cone assembly 36. In the illustrated embodiment, the cone assembly 36 comprises a substantially cone-shaped member 38 having absorptive interior surfaces 40 (FIG. 3). The cone-shaped member 38 tapers downward from a larger aperture 42 proximate the spectral filter assembly 30 to a smaller aperture 44 spaced from the spectral filter assembly 30. The tapered absorptive surfaces 40 within the cone-shaped member 38 capture and contain light rays 25 not traveling in the desired direction. Thus, when the filtered light exits the cone assembly 36 the range of angles within the filtered light is less than when the filtered light entered the cone assembly 36. For example, the range of angles of the light that exits the light source 22 and filter assembly 30 and that does not strike the reflector may range from zero to approximately ninety degrees, while the filtered light exiting the cone assembly 36 may range from zero to approximately fifteen degrees. Those of ordinary skill in the art will appreciate that these ranges are only examples, and not limiting. Since the light exiting the light source 22 may contain both UV and near infrared (NIR) radiation, capturing the “stray” light enhances the safety characteristics of the source assembly/solar simulator 20.

Although not pictured, the cone assembly 36 may include cooling apparatus if the light source 22 is of sufficient wattage to cause the cone assembly 36 to get hot during use. With reference to FIGS. 1 and 3, a distal end of the cone assembly 36 may include a shutter 46 to enable easy blocking of the light from the source assembly solar simulator 20. The shutter 46 acts as an ON/OFF switch for the simulator 20, even when the light source 22 remains illuminated.

With reference to FIGS. 1 and 2, after exiting the cone assembly 36, the filtered light enters a homogenizer 48. With reference to FIG. 2, the homogenizer 48 is shaped as an elongate box having a square cross-section. Those of ordinary skill in the art will appreciate that the homogenizer 48 could have any cross-sectional shape hi some embodiments, the cross-sectional shape of the homogenizer 48 may be chosen to match the shape of the optical sensor or solar cell 21 being tested. Thus, the cross-sectional shape may be rectangular, hexagonal, etc. In the illustrated embodiment, the homogenizer 48 has a constant cross-sectional area from a first end 50 proximate the cone assembly 36 to a second end 52 spaced from the cone assembly 36. In alternative embodiments, however, the homogenizer 48 may taper outward from the first end 50 to the second end 52. In still further alternative embodiments the homogenizer 48 may taper downward from the first end 50 to the second end 52. The tapering may occur with respect to only an interior width of the homogenizer 48, or with respect to both an interior width and an exterior width.

With continued reference to FIG. 2, the homogenizer 48 includes polished, smooth, flat and reflective inner surfaces 54. These surfaces 54 reflect, rather than scatter light. Light entering the homogenizer 48 undergoes multiple reflections as it propagates from the input end 50 to the output end 52. As the light input to the homogenizer 48 propagates through the homogenizer 48, the light mixes to produce a homogenized output beam 55. In one embodiment, the homogenized output beam 55 has substantially uniform distributions of irradiance and spectrum across the beam's cross-section. The substantially uniform distributions mimic the corresponding distributions present in sunlight striking Earth's surface. Those of ordinary skill in the art will appreciate that other distributions may also be achieved by proper selection of the homogenizer shape and size.

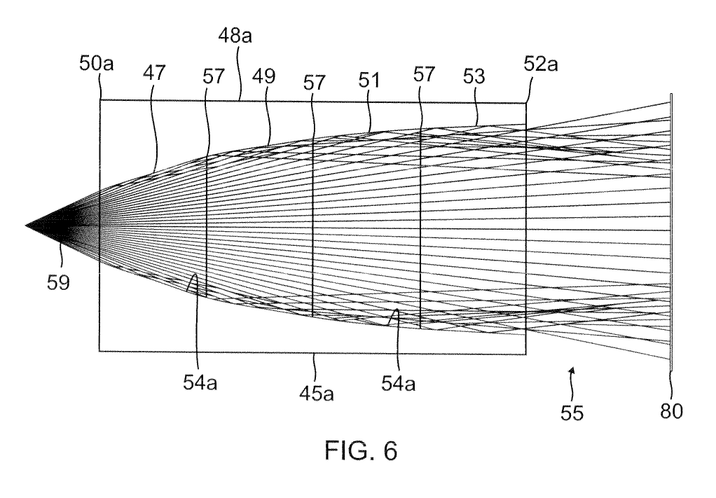

FIG. 6 illustrates an alternative embodiment of the homogenizer 48a. FIG. 6a is a schematic cross-sectional view of the homogenizer 48a, illustrating its exterior surfaces 45a and reflective interior surfaces 54a. The homogenizer 48a includes an interior taper, while the exterior surfaces 45a are not tapered. The interior surfaces 54a taper outwardly from the first end 50a to the second end 52a. Further, the taper occurs in graduated steps 47, 49, 51, 53, which are separated by transition boundaries 57. In the illustrated embodiment, four steps 47, 49, 51, 53 are shown, but those of ordinary skill in the alt will appreciate that any number of steps may be used. In the homogenizer 48a of FIG. 6, the taper angle decreases from the first graduated step 47 to the last 53. The resultant beam 55 exiting the homogenizer 48a has a smaller range of angles than the input beam 59 to the homogenizer 48a. Those of ordinary skill in the art will appreciate that various embodiments of the present homogenizer may include a variety of tapers, including graduated, smooth, increasing, decreasing, etc. The illustrated embodiments should not be interpreted as limiting.

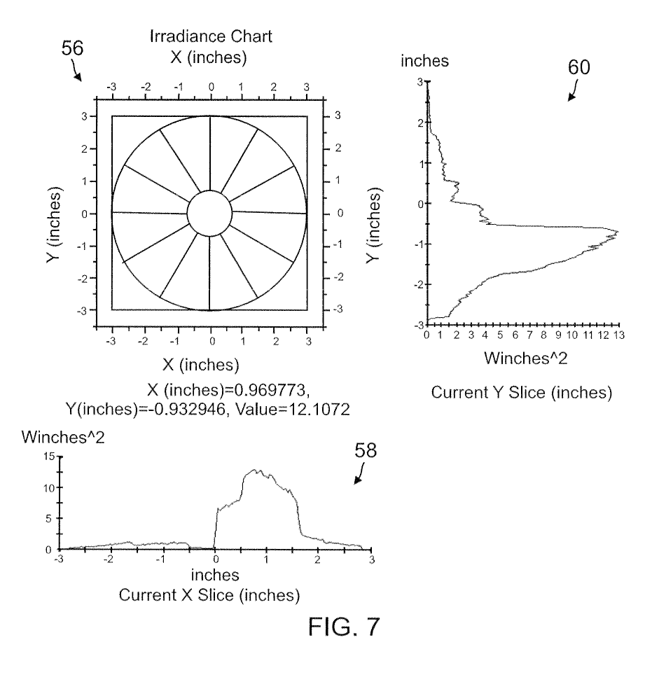

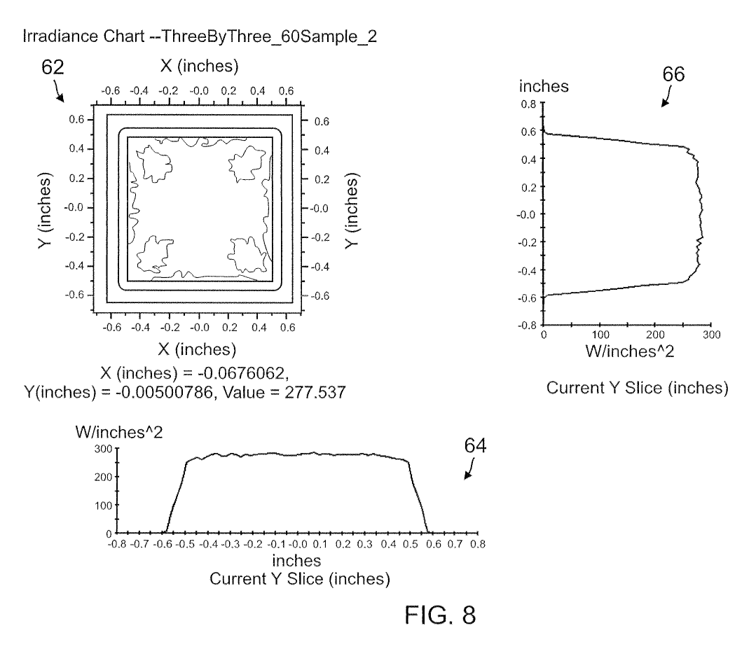

FIGS. 7 and 8 illustrate the spectral light mixing that takes place in the homogenizer 48. The chart 56 in the center of FIG. 7 illustrates the spectral content of the light input to the homogenizer 48. The light is broken up into six matched pairs of colored light according to the properties of the spectral filter assembly 30. The graph 58 below the chart 56 shows the power per unit area of a horizontal cross-section of the input beam taken through y≈0.93 inches. The graph 60 to the right of the chart 56 shows the power per unit area of a vertical cross-section of the input beam taken through x≈0.97 inches. Each graph shows greater power per unit area to one side of the center, illustrating the spectral asymmetry in the input beam in both the horizontal and vertical directions.

FIG. 8 illustrates the power distribution of the homogenizer output beam 55. The chart 62 in the upper left of FIG. 8 illustrates that the light is well mixed, as shown by the substantially uniform distribution of grays across the chart 62 in all directions. The graph 64 below the chart 62 shows the power per unit area of a horizontal cross-section of the output beam 55 taken through y≈−0.005 inches. The graph 66 to the right of the chart 62 shows the power per unit area of a vertical cross-section of the output beam 55 taken through x≈−0.068 inches. Each graph 64, 66 shows a balance in power per unit area to either side of the center, illustrating the spatial irradiance symmetry in the output beam 55 in both the horizontal and vertical directions.

The homogenized output beam 55 includes a range of angles determined by the geometry of the homogenizer 48. In some embodiments the range of angles may be the same as that of the filtered light exiting the cone assembly 36. In other embodiments, however, including those in which the homogenizer 48 tapers outward from its first end 50 to its second end 52, the range of angles within the beam 55 may be less than that of the filtered light exiting the cone assembly 36. For example, the beam 55 exiting the homogenizer 48 may include a range of angles from zero to approximately four degrees. Those of ordinary skill in the art will appreciate that this range is only one example, and not limiting.

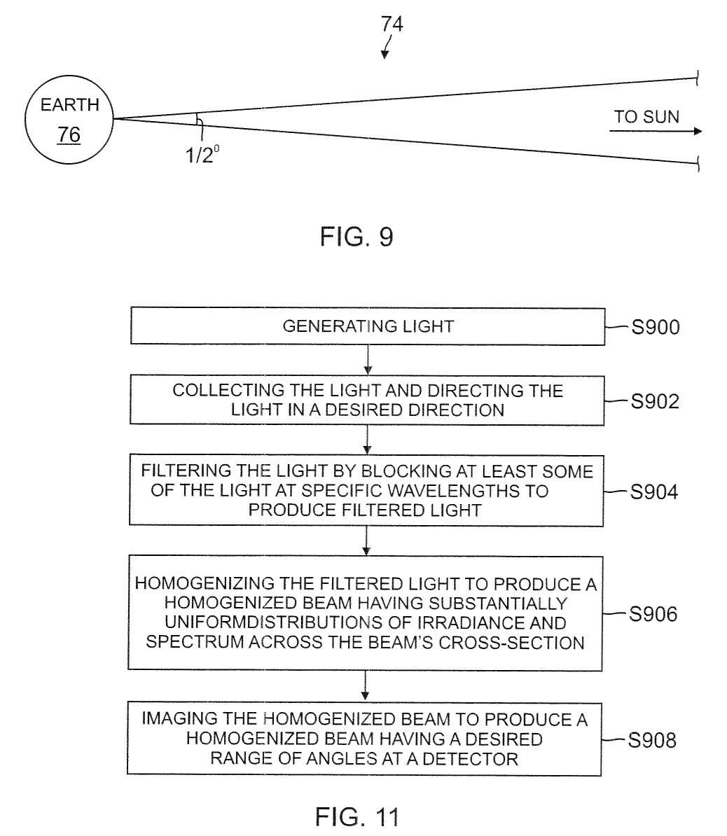

As shown in FIG. 9, sunlight 74 striking Earth's surface 76 has an angle of incidence of one-half of one degree. This quantity is equivalent to a range of angles of from zero to one-quarter of one degree. Thus, to closely simulate sunlight, the present source assembly/solar simulator 20 includes a lens assembly 78 (FIGS. 1 and 2) that images and sizes the output of the homogenizer 48. En one embodiment, the resultant image at plane 21 has a range of beam angles from 0 to 0.26 degrees from the surface normal, which mimics the range of angles present in sunlight striking Earth's surface. The imaging provided by the lens assembly 78 maintains the spatial and spectral characteristics of the beam.

With reference to FIGS. 1 and 2, the lens assembly 78 includes at least two lenses 80, 82. The lenses 80, 82 are spaced from the homogenizer 48 an appropriate distance to enable them to form an image. The spacing between the homogenizer 48 and the first lens 80, the spacing between the lenses 80, 82 (there may be more than two), and the optical characteristics of the lenses 80, 82 (focal lengths, refractive indices, radii of curTature, thickness, etc.) are all tailored to produce a desired beam image at a point in space distal of the lens assembly 78. For example, to simulate sunlight the range of angles within the beam may be from zero to one-quarter of one degree.

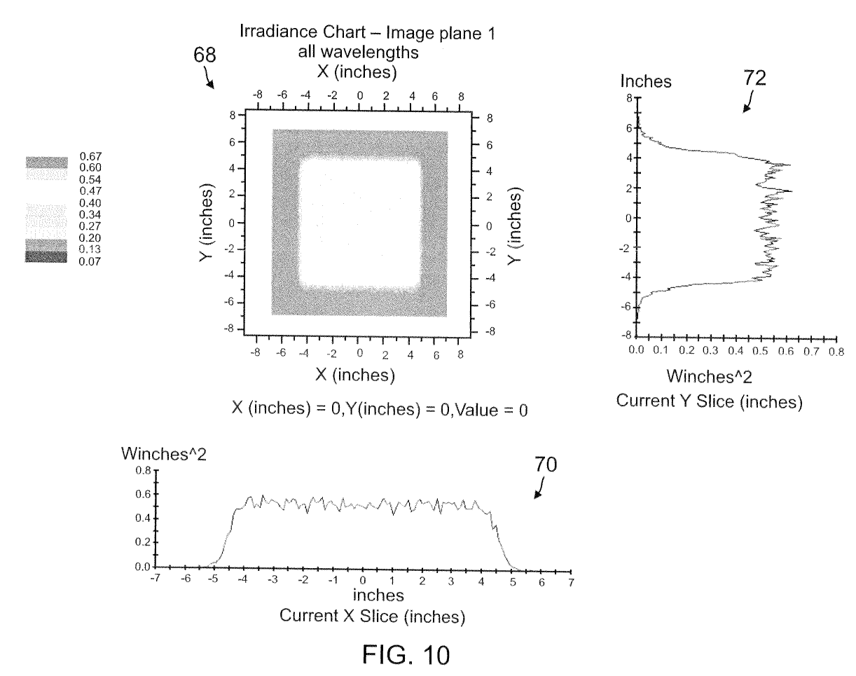

The chart 68 in the center of FIG. 10 illustrates the power distribution of the light after it has passed through the lens assembly 78. The light is well mixed, as illustrated by the substantially uniform distribution of power across the chart 68 in all directions. The graph 70 below the chart 68 shows the power per unit area of a horizontal cross-section of the light taken through y=0 inches. The graph 72 to the right of the chart 68 shows the power per unit area of a vertical cross-section of the v taken through x=0 inches. Each graph 70, 72 shows a balance in power per unit area to either side of the center, illustrating the spatial irradiance symmetry in the light in both the horizontal and vertical directions.

FIG. 11 illustrates one embodiment of a method for using the present source assembly/solar simulator 20 to test an optical sensor, such as a solar cell 21. The method includes the steps of generating light S900 and collecting the light and directing the light in a desired direction S902. In step S904 the light is filtered by blocking at least some of the light at specific wavelengths to produce filtered light. In step S906 the filtered light is homogenized to produce a homogenized beam having a substantially uniform distributions of irradiance and spectrum across the beam's cross-section. In step S908 the homogenized beam is imaged to produce a homogenized beam having a desired range of angles at a detector.

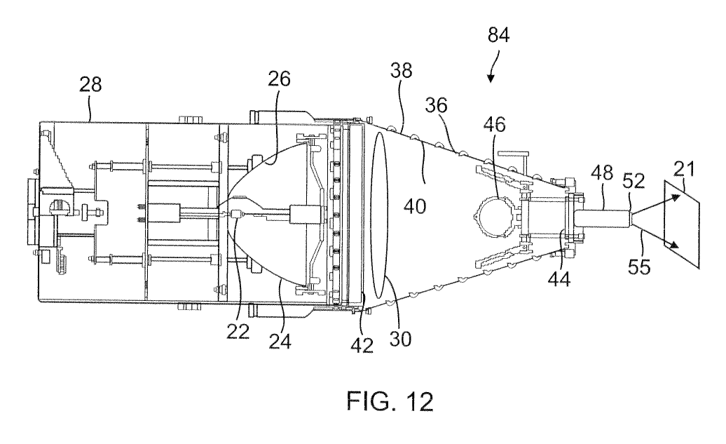

FIG. 12 illustrates another embodiment of the present optical source assembly/solar simulator 84. The optical source assembly/solar simulator 84 is similar to the optical source assembly/solar simulator 20 shown in FIGS. 1 and 2, and includes many of the same components as indicated by the common reference numerals. The optical source assembly/solar simulator 84 of FIG. 12, however, does not include a lens assembly for imaging and sizing the homogenizer output beam 55. The solar cell/optical sensor 21 being tested is also located closer to the second end 52 of the homogenizer 48. The embodiment 84 of FIG. 12 shares many of advantageous features with the embodiment 20 of FIG. 1. The homogenizer output beam 55 is substantially uniform in irradiance and spectrum, and has a very high light concentration. The embodiment 84 of FIG. 12 is thus useful for testing the individual cells. As shown in FIG. 12, the device 21 being tested is located very close to the second end 52 of the homogenizer, where the light concentration may be over 1000 times the intensity of the sun.

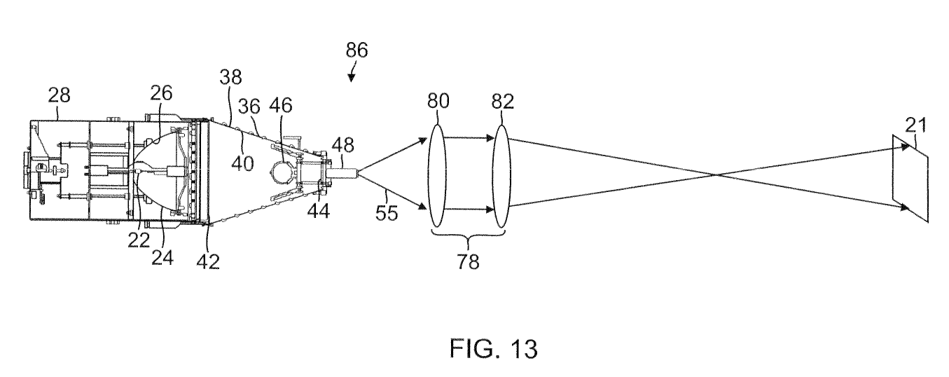

FIG. 13 illustrates another embodiment of the present optical source assembly/solar simulator 86. The optical source assembly/solar simulator 86 is similar to the optical source assembly/solar simulator 20 shown in FIGS. 1 and 2, and includes many of the same components as indicated by the common reference numerals. The optical source assembly/solar simulator 86 of FIG. 13, however, does not include a spectral filter assembly. The embodiment 86 of FIG. 13 is thus configured to shape and image light without spectral filtering.

The present source assembly/solar simulator 20, 84, 86 advantageously produces an output beam at a point in space that is well mixed spatially, spectrally balanced, and imaged to have a small range of angles. Solar cells or other optical sensors 21 can be placed at the image plane to be tested (FIG. 1). The irradiance level at this plane can be from one to five Suns, depending on the area illuminated, the filtering technique used and the size of lamp 22 used. By adjusting the filter elements 32, the user can adjust the content of each individual wavelength contribution while still maintaining the spatial and spectral balance across the test area. The spectral bands into which the light is broken up can easily be chosen by proper selection of the filter elements 32. The adjustability can be from 100% to 0% for any particular wavelength band. The source assembly/solar simulator 20, 84, 86 can be quickly and easily adjusted to virtually any integrated spectral distribution. It can be quickly and easily adjusted to starve one particular layer in a multi-junction solar cell to investigate that specific layer's performance and characteristics. With the proper optical diagnostics, it can continually adjust the spectral levels and distribution to maintain the system within specifications automatically. This adjustability can advantageously correct for such things as lamp age and thermal issues, which presently plague source assembly/solar simulators in testing environments.

### SCOPE OF THE INVENTION

The above description presents the best mode contemplated for carrying out the present source assembly/solar simulator and methods, and of the manner and process of making and using it, in such full, clear, concise, and exact terms as to enable any person skilled in the art to which it pertains to make and use this source assembly/solar simulator and these methods. This source assembly/solar simulator and these methods are, however susceptible to modifications and alternate constructions from that discussed above that are fully equivalent. Consequently, this source assembly/solar simulator and these methods are not limited to the particular embodiments disclosed. On the contrary, this source assembly/solar simulator and these methods cover all modifications and alternate constructions coming within the spirit and scope of the source assembly/solar simulator and methods as generally expressed by the following claims, which particularly point out and distinctly claim the subject matter of the source assemblies/solar simulator and methods.

What is claimed is:

1. Apparatus for shaping and spectrally filtering light, comprising:
a light source configured to generate light;
a reflector configured to collect the light and direct the light in a desired direction;
a spectral filter assembly configured to receive the light from the reflector and block at least some of the light at specific wavelengths to produce filtered light; and
a homogenizer configured to receive the filtered light and produce a homogenized beam having a substantially uniform irradiance distribution across the beam's cross-section and a substantially uniform spectral distribution across the beam's cross-section.

2. The apparatus of claim 1, further comprising a lens assembly configured to image the homogenized beam.

3. The apparatus of claim 2 wherein the lens assembly is further configured to size the homogenized beam.

4. The apparatus of claim 1, wherein the spectral filter assembly includes a plurality of filter elements.

5. The apparatus of claim 4, wherein the filter elements are wedge-shaped.

6. The apparatus of claim 4, wherein the filter elements are received in apertures of the spectral filter assembly.

7. The apparatus of claim 4, wherein the filter elements include a plurality of matched pairs of filter elements.

8. The apparatus of claim 7, wherein the filter elements include six matched pairs of filter elements.

9. The apparatus of claim 7, wherein members of each matched pair are arranged opposite one another.

10. The apparatus of claim 1, wherein the homogenizer comprises an elongate tubular member having reflective inner surfaces.

11. The apparatus of claim 10, wherein the homogenizer has a substantially rectangular cross-section.

12. The apparatus of claim 10, wherein the homogenizer tapers along at least a portion of its length from a smaller cross-sectional area to a larger cross-sectional area.

13. The apparatus of claim 10, wherein the homogenizer tapers along at least a portion of its length from a larger cross-sectional area to a smaller cross-sectional area.

14. The apparatus of claim 1, further comprising a cone assembly located between the spectral filter assembly and the homogenizer, the cone assembly being configured to capture and contain a portion of the light not traveling in a desired direction.

15. The apparatus of claim 1, wherein the homogenizer and the lens assembly are matched to one another to produce a desired image of the light striking a detector.

16. Apparatus for shaping and imaging light, comprising:
a light source configured to generate light;
a reflector configured to collect the light and direct the light in a desired direction;
a homogenizer configured to receive the light and produce a homogenized beam having a substantially uniform irradiance distribution across the beam's cross-section and a substantially uniform spectral distribution across the beam's cross-section; and
a lens assembly configured to image the homogenized beam.

17. The apparatus of claim 16, wherein the lens assembly is further configured to size the homogenized beam.

18. The apparatus of claim 16, wherein the homogenizer comprises an elongate tubular member having reflective inner surfaces.

19. The apparatus of claim 18, wherein the homogenizer has a substantially rectangular cross-section.

20. The apparatus of claim 18, wherein the homogenizer tapers along at least a portion of its length from a smaller cross-sectional area to a larger cross-sectional area.

21. The apparatus of claim 18, wherein the homogenizer tapers along at least a portion of its length from a larger cross-sectional area to a smaller cross-sectional area.

22. The apparatus of claim 16, further comprising a cone assembly located between the light source and the homogenizer, the cone assembly being configured to capture and contain a portion of the light not traveling in a desired direction.

23. The apparatus of claim 16, wherein the homogenizer and the lens assembly are matched to one another to produce a desired image of the light striking a detector.

24. A method for simulating sunlight, the method comprising the steps of:
generating light;
collecting the light and directing the tight in a desired direction;
filtering the light by blocking at least some of the light at specific wavelengths to produce filtered light; and
homogenizing the filtered light to produce a homogenized beam having a substantially uniform irradiance distribution across the beam's cross-section and a substantially uniform spectral distribution across the beam's cross-section.

25. The method of claim 24, further comprising the step of imaging the homogenized beam to produce a homogenized beam having a desired range of angles at a detector.

26. The method of claim 24, wherein the step of filtering the light comprises passing the light through a spectral filter assembly including a plurality of filter elements.

27. The method of claim 26 wherein the filter elements are wedge-shaped.

28. The method of claim 26, wherein the filter elements include a plurality of matched pairs of filter elements.

29. The method of claim 28, wherein the filter elements include six matched pairs of filter elements.

30. The method of claim 24, wherein the step of homogenizing the filtered light comprises passing the light through an elongate tubular member having reflective inner surfaces.

31. The method of claim 30, wherein the homogenizer has a substantially rectangular cross-section.

32. The method of claim 30, wherein the homogenizer tapers along at least a portion of its length from a smaller cross-sectional area to a larger cross-sectional area.

33. The method of claim 30, wherein the homogenizer tapers along at least a portion of its length from a larger cross-sectional area to a smaller cross-sectional area.

34. The method of claim 24, wherein the step of imaging the homogenized beam comprises passing the homogenized beam through a lens assembly.

35. The method of claim 24, further comprising the step of matching the homogenizer and the lens assembly to one another to produce a desired focus of the light striking a detector.
